(19) United States
(12) Patent Application Publication
(10) Pub. No.: US 2019/0116374 A1
(43) Pub. Date: Apr. 18, 2019

(54) CODING MOTION INFORMATION OF VIDEO DATA USING CODING STRUCTURE-BASED CANDIDATE LIST CONSTRUCTION

(71) Applicant: QUALCOMM Incorporated, San Diego, CA (US)

(72) Inventors: Kai Zhang, San Diego, CA (US); Jianle Chen, San Diego, CA (US); Marta Karczewicz, San Diego, CA (US)

(21) Appl. No.: 16/161,938

(22) Filed: Oct. 16, 2018

Related U.S. Application Data
(60) Provisional application No. 62/573,607, filed on Oct. 17, 2017.

(51) Int. Cl. H04N 19/513; H04N 19/119; H04N 19/176; H04N 19/96

(52) U.S. Cl. CPC H04N 19/513; H04N 19/96; H04N 19/176; H04N 19/119

(57) ABSTRACT

An example device for coding video data includes a memory comprising circuitry configured to store video data; and one or more processors implemented in circuitry and configured to partition a parent block of the video data into a neighboring child block and a current child block, wherein the neighboring child block and the current child block correspond to leaf nodes of a partition tree structure for the parent block, in response to partitioning the parent block into the neighboring child block and the current child block, construct a motion candidate list for the current child block including a plurality of motion vector candidates such that the plurality of motion vector candidates omit data representative of a motion vector for the neighboring child block; and code motion information of the current child block using one of the plurality of motion vector candidates.

This application claims the benefit of U.S. Provisional Application No. 62/573,607, filed Oct. 17, 2017, the entire content of which is hereby incorporated by reference.

### TECHNICAL FIELD

This disclosure relates to video coding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard, ITU-T H.265/High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for coding motion information, such as motion vectors, of video data. More particularly, the techniques of this disclosure include construction of candidate lists for prediction of motion vectors during motion information coding based on coding structures.

In one example, a method of coding (e.g., encoding or decoding) video data includes partitioning a parent block of video data into a neighboring child block and a current child block, wherein the neighboring child block and the current child block correspond to leaf nodes of a partition tree structure for the parent block, in response to partitioning the parent block into the neighboring child block and the current child block, constructing a motion candidate list for the current child block including a plurality of motion vector candidates such that the plurality of motion vector candidates omit data representative of a motion vector for the neighboring child block, and coding motion information of the current child block using one of the plurality of motion vector candidates.

In another example, a device for coding video data includes a memory comprising circuitry configured to store video data; and one or more processors implemented in circuitry and configured to partition a parent block of the video data into a neighboring child block and a current child block, wherein the neighboring child block and the current child block correspond to leaf nodes of a partition tree structure for the parent block, in response to partitioning the parent block into the neighboring child block and the current child block, construct a motion candidate list for the current child block including a plurality of motion vector candidates such that the plurality of motion vector candidates omit data representative of a motion vector for the neighboring child block, and code motion information of the current child block using one of the plurality of motion vector candidates.

In another example, a computer-readable storage medium has stored thereon instructions that, when executed, cause one or more processors to partition a parent block of video data into a neighboring child block and a current child block, wherein the neighboring child block and the current child block correspond to leaf nodes of a partition tree structure for the parent block, in response to partitioning the parent block into the neighboring child block and the current child block, construct a motion candidate list for the current child block including a plurality of motion vector candidates such that the plurality of motion vector candidates omit data representative of a motion vector for the neighboring child block, and code motion information of the current child block using one of the plurality of motion vector candidates.

In another example, a device for coding video data includes means for partitioning a parent block of video data into a neighboring child block and a current child block, wherein the neighboring child block and the current child block correspond to leaf nodes of a partition tree structure for the parent block, means for constructing a motion candidate list for the current child block including a plurality of motion vector candidates such that the plurality of motion vector candidates omit data representative of a motion vector for the neighboring child block in response to partitioning the parent block into the neighboring child block and the current child block, and means for coding motion information of the current child block using one of the plurality of motion vector candidates.

The details of one or more examples are set forth in the accompanying drawings and the description below. Other features, objects, and advantages will be apparent from the description, drawings, and claims.

### BRIEF DESCRIPTION OF DRAWINGS

FIGS. 1A and 1B are conceptual diagrams illustrating spatial neighboring motion vector candidates for motion vector prediction of high efficiency video coding (HEVC).

FIGS. 2A and 2B are conceptual diagrams illustrating techniques relating to temporal motion vector predictor (TMVP) candidates and motion vector scaling according to HEVC.

FIG. 3 is a conceptual diagram illustrating an example set of spatial merging candidates of HEVC.

FIG. 4 is a flow diagram illustrating an example process for constructing a merge candidate list according to HEVC.

FIG. 5 is a block diagram illustrating an example video encoding and decoding system that may utilize techniques for coding motion information.

FIGS. 6A and 6B are conceptual diagrams illustrating an example quadtree binary tree (QTBT) structure, and a corresponding coding tree unit (CTU).

FIGS. 7A-7C are conceptual diagrams illustrating examples of situations in which a video encoder and a video decoder may avoid checking data of neighboring block A1 of FIG. 3.

FIGS. 8A-8C are conceptual diagrams illustrating examples of situations in which a video encoder and a video decoder may avoid checking data of neighboring block B1 of FIG. 3.

FIG. 9 is a block diagram illustrating an example of a video encoder that may implement techniques for coding motion information of this disclosure.

FIG. 10 is a block diagram illustrating an example of a video decoder that may implement techniques for coding motion information of this disclosure.

FIG. 11 is a flowchart illustrating an example method for encoding a current block according to the techniques of this disclosure.

FIG. 12 is a flowchart illustrating an example method for decoding a current block of video data according to the techniques of this disclosure.

### DETAILED DESCRIPTION

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. A joint draft of MVC is described in “Advanced video coding for generic audiovisual services,” ITU-T Recommendation H.264, March 2010. In addition, there is a newly developed video coding standard, namely ITU-T H.265, also referred to as High Efficiency Video Coding (HEVC), developed by the Joint Collaboration Team on Video Coding (JCT-VC) of ITU-T Video Coding Experts Group (VCEG) and ISO/IEC Motion Picture Experts Group (MPEG). A draft of HEVC is available from phenix.int-evry.fr/jct/doc_end_user/documents/12_Geneva/wg11/JCTVC-L1003-v34.zip.

The techniques of this disclosure are generally related to coding (encoding and decoding) motion information, such as prediction and coding of motion vectors. In general, video coding includes partitioning a picture into individual blocks, and then coding data for the blocks. A video coder (such as a video encoder or a video decoder) may predict the blocks using inter-prediction or intra-prediction. Intra-prediction generally involves predicting blocks from neighboring data of the same picture, while inter-prediction generally involves predicting blocks from reference blocks of previously coded pictures. In particular, motion vectors of blocks may identify the reference blocks. The motion vectors themselves form part of motion information, and may be predictively coded as well. For example, a video coder may predict a motion vector from a motion vector predictor, which the video coder may select from a set of motion candidates in a motion candidate list. In accordance with the techniques of this disclosure, the video coder may construct the motion candidate list based on coding structures.

According to HEVC, for example, for each inter-predicted block of a picture, a set of motion information may be available. The set of motion information may contain motion information for forward and/or backward prediction directions. Here, forward and backward prediction directions are two prediction directions corresponding to reference picture list 0 (RefPicList0) and reference picture list 1 (RefPicList1) of a current picture or slice, respectively. The terms “forward” and “backward” do not necessarily have a geometric meaning. Instead, they are used to distinguish which reference picture list a motion vector is based on. Forward prediction means the prediction formed based on reference picture list 0, while backward prediction means the prediction formed based on reference picture list 1. Bi-directional prediction refers to the case in which both reference list 0 and reference list 1 are used to form a prediction block for a given block.

In HEVC, for a given picture or slice, if only one reference picture list is used, every block inside the picture or slice is forward predicted. If both reference picture lists are used for a given picture or slice, a block inside the picture or slice may be forward predicted, or backward predicted, or bi-directionally predicted.

For each prediction direction, per HEVC, the motion information contains a reference index and a motion vector. A reference index is used to identify a reference picture in the corresponding reference picture list (e.g. RefPicList0 or RefPicList1). A motion vector has both a horizontal and a vertical component, with each indicating an offset value along horizontal and vertical direction respectively. In some descriptions, for simplicity, the phrase “motion vector” may be used interchangeably with motion information, to indicate both the motion vector and its associated reference index.

Picture order count (POC) is widely used in video coding standards, such as HEVC, to identify a display order of a picture. Although there are cases in which two pictures within one coded video sequence may have the same POC value, this typically does not happen within a coded video sequence. When multiple coded video sequences are present in a bitstream, pictures with a same value of POC may be closer to each other in terms of decoding order. POC values of pictures are typically used for reference picture list construction, derivation of reference picture set as in HEVC and motion vector scaling.

In H.264/AVC, each inter-predicted macroblock (MB) may be partitioned in one of four different ways:

One 16×16 MB partition

Two 16×8 MB partitions

Two 8×16 MB partitions

Four 8×8 MB partitions

Per H.264/AVC, different MB partitions in one MB may have different reference index values for each direction (RefPicList0 or RefPicList1). When an MB is not partitioned into four 8×8 MB partitions, it has only one motion vector for each MB partition in each direction. When an MB is partitioned into four 8×8 MB partitions, each 8×8 MB partition can be further partitioned into sub-blocks, each of which can have a different motion vector in each direction. There are four different ways to get sub-blocks from an 8×8 MB partition:

One 8×8 sub-block

Two 8×4 sub-blocks

Two 4×8 sub-blocks

Four 4×4 sub-blocks

Each sub-block can have a different motion vector in each direction. Therefore, a motion vector is present in a level equal to or higher than sub-blocks in H.264/AVC.

In H.264/AVC, temporal direct mode can be enabled in either MB or MB partition level for skip or direct mode in B slices. For each MB partition, the motion vectors of the block co-located with the current MB partition in the RefPicList1[ 0] of the current block are used to derive the motion vectors. Each motion vector in the co-located block is scaled based on POC distances. In H.264/AVC, a direct mode can also be used to predict motion information from the spatial neighbors.

In HEVC, the largest coding unit in a slice is called a coding tree block (CTB) or coding tree unit (CTU). A CTB contains a quad-tree the nodes of which are coding units. The size of a CTB can be ranges from 16×16 to 64×64 in the HEVC main profile (although technically 8×8 CTB sizes can be supported). A coding unit (CU) could be the same size of a CTB although and as small as 8×8. Each coding unit is coded with one mode. When a CU is inter coded, it may be further partitioned into 2 or 4 prediction units (PUs) or become just one PU when further partition doesn't apply. When two PUs are present in one CU, they can be half size rectangles or two rectangle size with ¼ or ¾ size of the CU. When the CU is inter coded, one set of motion information is present for each PU. In addition, each PU is coded with a unique inter-prediction mode to derive the set of motion information.

In HEVC, there are two inter prediction modes, named merge (skip is considered as a special case of merge) and advanced motion vector prediction (AMVP) modes respectively for a prediction unit (PU). In either AMVP or merge mode, a motion vector (MV) candidate list is maintained for multiple motion vector predictors. The motion vector(s), as well as reference indices in the merge mode, of the current PU are generated by taking one candidate from the MV candidate list.

The MV candidate list of HEVC contains up to 5 candidates for the merge mode and only two candidates for the AMVP mode. A merge candidate may contain a set of motion information, e.g., motion vectors corresponding to both reference picture lists (list 0 and list 1) and the reference indices. If a merge candidate is identified by a merge index, the reference pictures are used for the prediction of the current blocks, as well as the associated motion vectors are determined. However, under AMVP mode for each potential prediction direction from either list 0 or list 1, a reference index needs to be explicitly signaled, together with an MVP index to the MV candidate list since the AMVP candidate contains only a motion vector. In AMVP mode, the predicted motion vectors can be further refined. As can be seen above, a merge candidate corresponds to a full set of motion information while an AMVP candidate contains just one motion vector for a specific prediction direction and reference index. A video coder derives candidates for both modes similarly from the same spatial and temporal neighboring blocks.

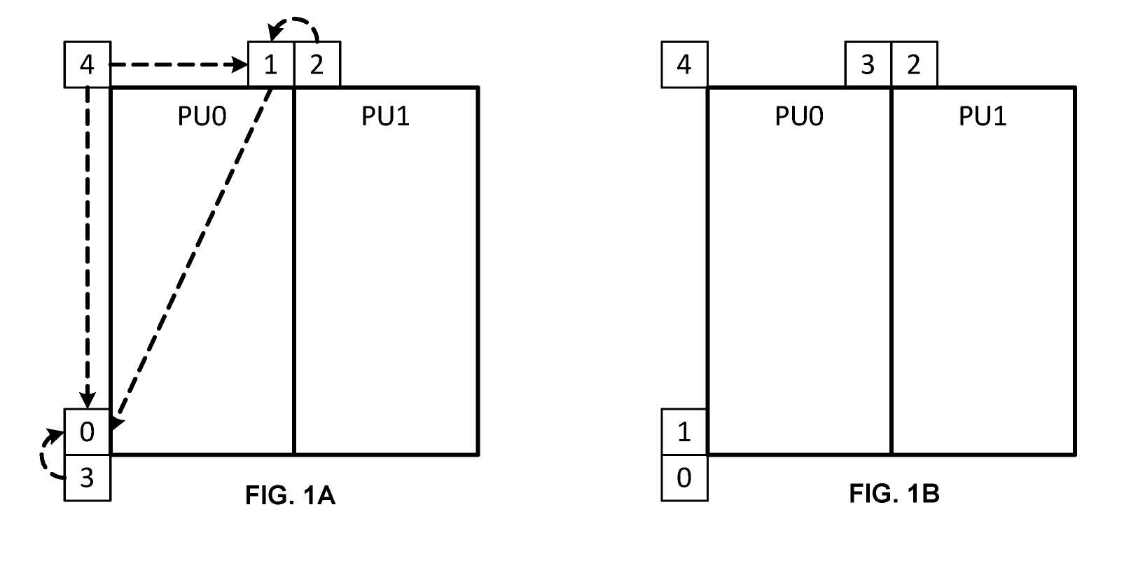

FIGS. 1A and 1B are conceptual diagrams illustrating spatial neighboring motion vector candidates for motion vector prediction of HEVC. In particular, FIG. 1A illustrates candidates for merge mode, and FIG. 1B illustrates candidates for AMVP. A video coder derives spatial MV candidates from neighboring blocks as shown in FIGS. 1A and 1B, for a specific PU (PU₀), although the methods generating the candidates from the blocks differ for merge and AMVP modes.

In particular, in merge mode per HEVC, up to four spatial MV candidates can be derived with the orders shown in FIG. 1A with numbers, and the order is the following: left (0, A1), above (1, B1), above right (2, B0), below left (3, A0), and above left (4, B2), as shown in FIG. 1A.

In AVMP mode per HEVC, the neighboring blocks are divided into two groups: a left group including blocks 0 and 1, and an above group including blocks 2, 3, and 4 as shown in FIG. 1B. For each group, the potential candidate in a neighboring block referring to the same reference picture as that indicated by the signaled reference index has the highest priority to be chosen to form a final candidate of the group. It is possible that no neighboring blocks contain a motion vector pointing to the same reference picture. Therefore, if such a candidate cannot be found, the first available candidate will be scaled to form the final candidate; thus the temporal distance differences can be compensated.

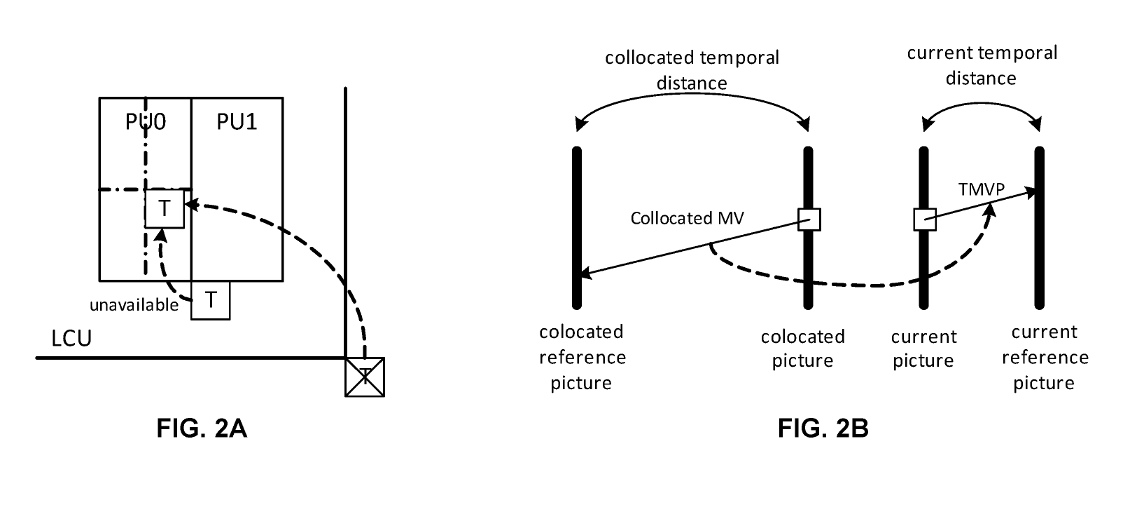

FIGS. 2A and 2B are conceptual diagrams illustrating techniques relating to temporal motion vector predictor (TMVP) candidates and motion vector scaling according to HEVC. In particular, FIG. 2A illustrates TMVP candidates, while FIG. 2B illustrates MV scaling for TMVP.

When TMVP is enabled and available, per HEVC, a video coder adds a TMVP candidate into the MV candidate list after spatial motion vector candidates. The process of motion vector derivation for TMVP candidate is the same for both merge and AMVP modes. However, the target reference index for the TMVP candidate in the merge mode is always set to 0.

The primary block location for a TMVP candidate derivation is the bottom-right block outside of the collocated PU, as shown in FIG. 2A as a block “T,” to compensate the bias to the above and left blocks used to generate spatial neighboring candidates. However, if that block is located outside of the current CTB row or motion information is not available, the block is substituted with a center block of the PU, as also shown in FIG. 2A.

According to HEVC, a motion vector for the TMVP candidate is derived from the co-located PU of the co-located picture, indicated in the slice level. The motion vector for the co-located PU is called the collocated MV. Similar to temporal direct mode in H.264/AVC, to derive the TMVP candidate motion vector, the co-located MV need to be scaled to compensate the temporal distance differences, as shown in FIG. 2B.

HEVC describes additional techniques related to merge and AMVP modes. For example, according to HEVC, a video coder may scale motion vectors. It is assumed that the value of a motion vector is proportional to the distance between pictures in presentation time. A motion vector associates two pictures, the reference picture and the picture containing the motion vector (namely the containing picture or current picture). When a motion vector is used to predict another motion vector, the distance of the containing picture and the reference picture is calculated based on the Picture Order Count (POC) values for these pictures. For a motion vector to be predicted, both its associated containing picture and reference picture may be different. Therefore, a new distance (based on POC) is calculated. And the motion vector is scaled based on these two POC distances. For a spatial neighboring candidate, the containing pictures for the two motion vectors are the same, while the reference pictures are different. In HEVC, motion vector scaling applies to both TMVP and AMVP for spatial and temporal neighboring candidates.

HEVC also describes techniques for generating artificial motion vector candidates. If a motion vector candidate list is not complete, artificial motion vector candidates may be generated and inserted at the end of the list until it has all needed candidates. In merge mode, there are two types of artificial MV candidates: combined bi-prediction candidates, derived only for B-slices, and default fixed candidates. Only zero candidate is used for AMVP if the first type does not provide enough artificial candidates. For each pair of candidates that are already in the candidate list and have necessary motion information, bi-directional combined motion vector candidates are derived by a combination of the motion vector of the first candidate referring to a picture in the list 0 and the motion vector of a second candidate referring to a picture in the list 1.

HEVC also describes a pruning process for candidate insertion into candidate lists. Candidates from different blocks may happen to be the same, which decreases the efficiency of a merge/AMVP candidate lists. A video coder according to HEVC applies a pruning process to solve this problem. According to this process, the video coder compares one candidate against the others in the current candidate list to avoid inserting identical candidates, to a certain extent. To reduce the complexity, only limited numbers of pruning are applied, instead of comparing each potential one with all the other existing ones.

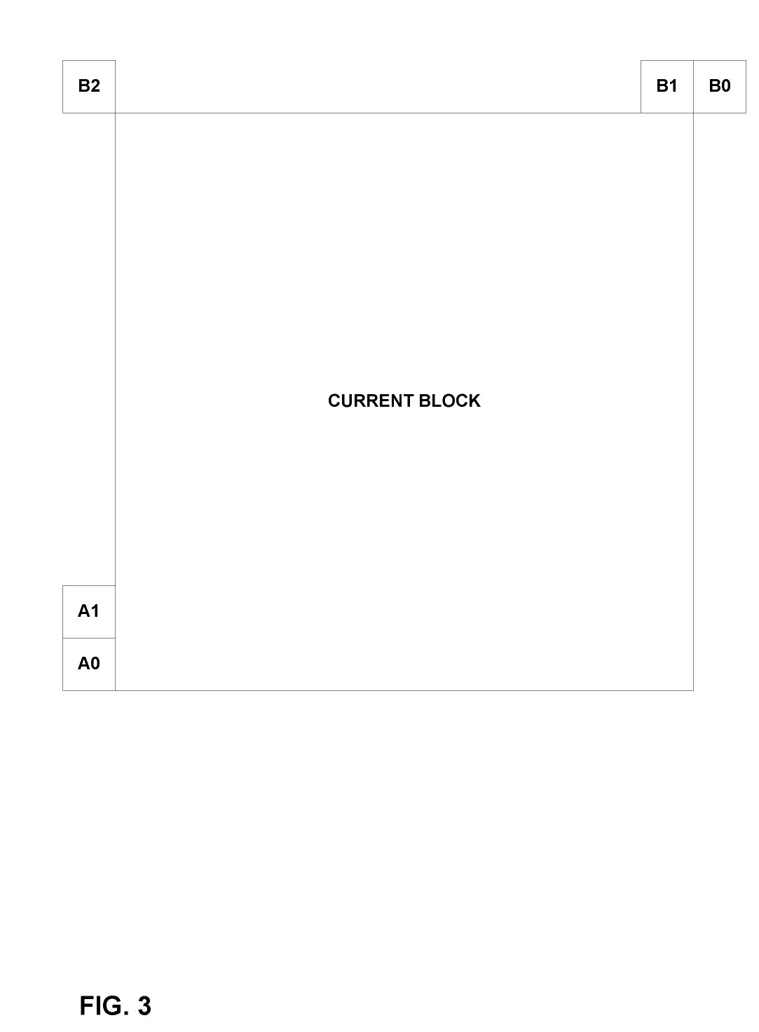

FIG. 3 is a conceptual diagram illustrating an example set of spatial merging candidates of HEVC. As discussed above, there are a variety of priority-based candidate lists. That is, for a priority-based candidate list, each candidate is inserted into the candidate list per a predefined priority. For example, in HEVC, merge candidate list and AMVP candidate list are constructed by inserting candidates based on a predefined order (or per a predefined priority). As shown in FIG. 3, the merge candidate list is constructed by inserting the spatial merging candidate by a predefined order (A1→B1→B0→A0→B2).

In FIG. 3, block A0 represents an example of a lowest left-neighboring block to the current block. Block A1 represents an example of a left-neighboring block that is above the lowest left-neighboring block to the current block. Block B1 represents an example of an above-right neighboring block to the current block.

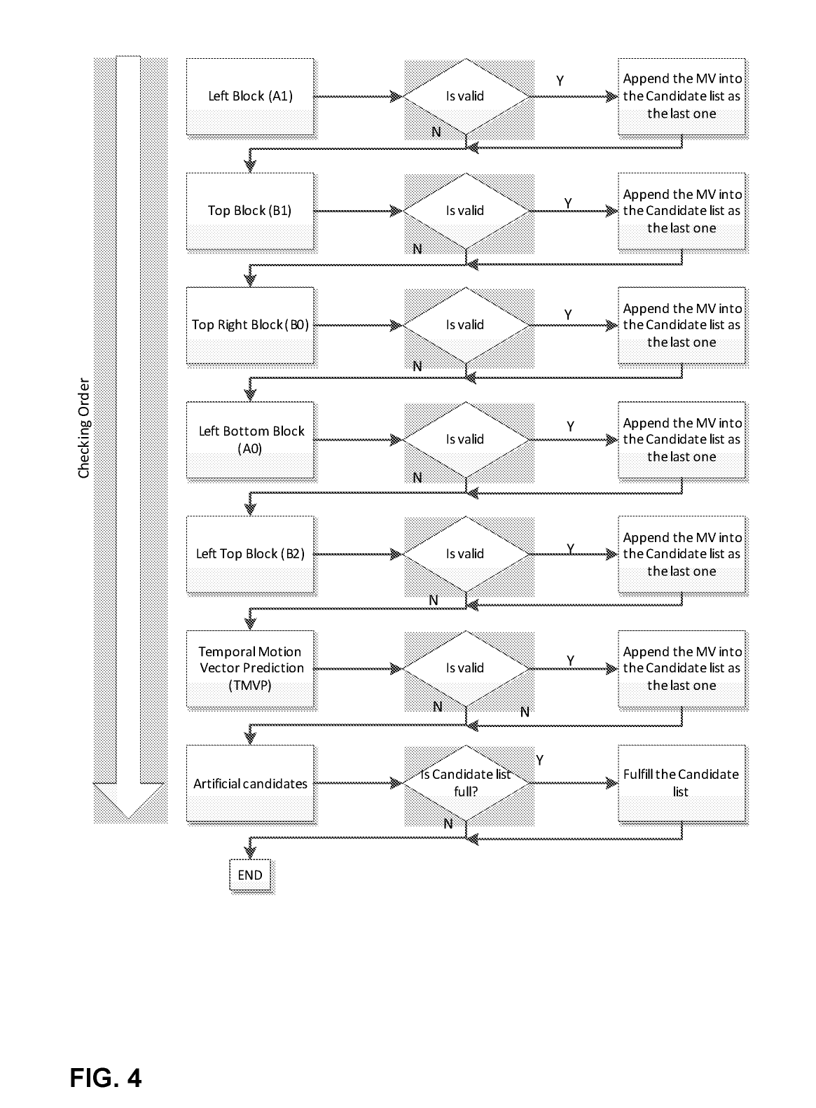

FIG. 4 is a flow diagram illustrating an example process for constructing a merge candidate list according to HEVC. In this example, each spatial or temporal neighboring block is checked one by one to identify whether the neighboring block can provide a valid merge candidate. The term “valid” means the block exists, is inter-prediction coded, the candidate list is not full, and the motion information in the block is not pruned by existing candidates in the current candidate list. If the merge candidate list is not full after checking all spatial and temporal neighboring blocks, the artificial candidates will be added to fulfill the merge candidate list. The term “blocks” (e.g. Block0 to Block4 and Current Block) used here can be coding unit/block, prediction unit/block, sub-PU, transform unit/block or any other coding structures.

In HEVC, the largest coding unit in a slice is called a coding tree unit (CTU). A CTU contains a quad-tree the nodes of which are coding units. The size of a CTU can range from 16×16 samples (or pixels) to 64×64 samples in the HEVC main profile (although technically 8×8 CTU sizes can be supported). A coding unit (CU) can be the same size as a CTU or as small as 8×8 in HEVC. Each coding unit is coded with one mode. When a CU is inter coded, it may be further partitioned into 2 or 4 prediction units (PUs) or become just one PU when further partition does not apply. When two PUs are present in one CU, they can be half size rectangles or two rectangle size with ¼ or ¾ size of the CU. When a CU is inter coded, one set of motion information is present for each PU. In addition, each PU is coded with a unique inter-prediction mode to derive the set of motion information.

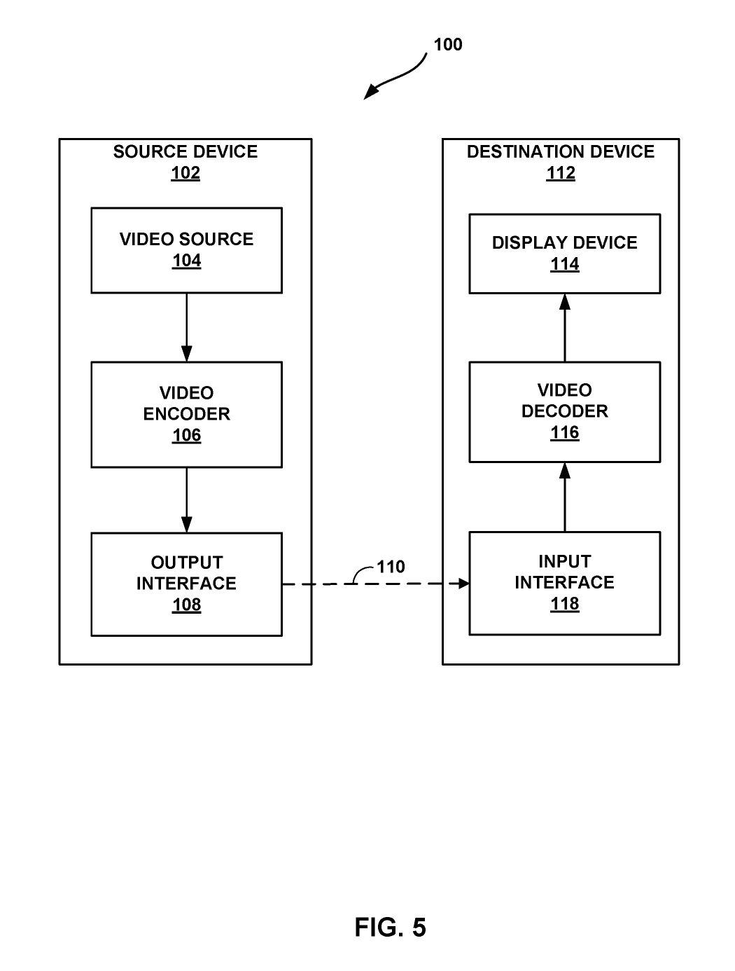

FIG. 5 is a block diagram illustrating an example video encoding and decoding system 100 that may utilize techniques for coding motion information. As shown in FIG. 5, system 100 includes a source device 102 that provides encoded video data to be decoded at a later time by a destination device 112. In particular, source device 102 provides the video data to destination device 112 via a computer-readable medium 110. Source device 102 and destination device 112 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 102 and destination device 112 may be equipped for wireless communication.

Destination device 112 may receive the encoded video data to be decoded via computer-readable medium 110. Computer-readable medium 110 may comprise any type of medium or device capable of moving the encoded video data from source device 102 to destination device 112. In one example, computer-readable medium 110 may comprise a communication medium to enable source device 102 to transmit encoded video data directly to destination device 112 in real-time. The encoded video data may be modulated according to a communication standard, such as a wireless communication protocol, and transmitted to destination device 112. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 112.

In some examples, encoded data may be output from output interface 108 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 102. Destination device 112 may access stored video data from the storage device via streaming or download. The file server may be any type of server capable of storing encoded video data and transmitting that encoded video data to the destination device 112. Example file servers include a web server (e.g., for a website), an FTP server, network attached storage (NAS) devices, or a local disk drive. Destination device 112 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 100 may be configured to support one-way or two-way video transmission to support applications such as video streaming, video playback, video broadcasting, and/or video telephony.

In the example of FIG. 5, source device 102 includes video source 104, video encoder 106, and output interface 108. Destination device 112 includes input interface 118, video decoder 116, and display device 114. In accordance with this disclosure, video encoder 106 of source device 102 may be configured to apply the techniques for coding motion information. In other examples, a source device and a destination device may include other components or arrangements. For example, source device 102 may receive video data from an external video source 104, such as an external camera. Likewise, destination device 112 may interface with an external display device, rather than including an integrated display device.

The illustrated system 100 of FIG. 5 is merely one example. Techniques for coding motion information may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 102 and destination device 112 are merely examples of such coding devices in which source device 102 generates coded video data for transmission to destination device 112. In some examples, devices 102, 112 may operate in a substantially symmetrical manner such that each of devices 102, 112 include video encoding and decoding components. Hence, system 100 may support one-way or two-way video transmission between video devices 102, 112, e.g., for video streaming, video playback, video broadcasting, or video telephony.

Video source 104 of source device 102 may include a video capture device, such as a video camera, a video archive containing previously captured video, and/or a video feed interface to receive video from a video content provider. As a further alternative, video source 104 may generate computer graphics-based data as the source video, or a combination of live video, archived video, and computer-generated video. In some cases, if video source 104 is a video camera, source device 102 and destination device 112 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 106. The encoded video information may then be output by output interface 108 onto a computer-readable medium 110.

Computer-readable medium 110 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 102 and provide the encoded video data to destination device 112, e.g., via network transmission. Similarly, a computing device of a medium production facility, such as a disc stamping facility, may receive encoded video data from source device 102 and produce a disc containing the encoded video data. Therefore, computer-readable medium 110 may be understood to include one or more computer-readable media of various forms, in various examples.

Input interface 118 of destination device 112 receives information from computer-readable medium 110. The information of computer-readable medium 110 may include syntax information defined by video encoder 106, which is also used by video decoder 116, that includes syntax elements that describe characteristics and/or processing of blocks and other coded units. Display device 114 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 106 and video decoder 116 may operate according to a video coding standard, such as ITU-T H.265, also referred to as High Efficiency Video Coding (HEVC) or extensions thereto, such as the multi-view and/or scalable video coding extensions. Alternatively, video encoder 106 and video decoder 116 may operate according to other proprietary or industry standards, such as the Joint Exploration Test Model (JEM). The techniques of this disclosure, however, are not limited to any particular coding standard. Although not shown in FIG. 5, in some aspects, video encoder 106 and video decoder 116 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 106 and video decoder 116 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 106 and video decoder 116 may be included in one or more encoders or decoders, either of which may be integrated as part of a combined encoder/decoder (CODEC) in a respective device. A device including video encoder 106 and/or video decoder 116 may comprise an integrated circuit, a microprocessor, and/or a wireless communication device, such as a cellular telephone.

HEVC defines various coding blocks, including coding units (CUs), prediction units (PUs), and transform units (TUs). According to HEVC, a video coder (such as video encoder 106) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The PUs and TUs may be further partitioned. For example, partitioning of TUs is represented by a residual quadtree (RQT). In HEVC, PUs represent inter-prediction data, while TUs represent residual data. CUs that are intra-predicted include intra-prediction information, such as an intra-mode indication.

According to JEM, a video coder (such as video encoder 106) partitions a picture into a plurality of coding tree units (CTUs). Video encoder 106 may partition a CTU according to a quadtree-binary tree (QTBT) structure. The QTBT structure of JEM removes the concepts of multiple partition types, such as the separation between CUs, PUs, and TUs of HEVC. A QTBT structure of JEM includes two levels: a first level partitioned according to quadtree partitioning, and a second level partitioned according to binary tree partitioning. A root node of the QTBT structure corresponds to a CTU. Leaf nodes of the binary trees correspond to coding units (CUs).

In general, video encoder 106 and video decoder 116 may code video data represented in a YUV (e.g., Y, Cb, Cr) format. That is, rather than coding red, green, and blue data for samples of a picture, video encoder 106 and video decoder 116 may code luminance and chrominance components, where the chrominance components may include both red hue and blue hue chrominance components. In some examples, video encoder 106 and video decoder 116 may use a single QTBT structure to represent each of the luminance and chrominance components, while in other examples, video encoder 106 and video decoder 116 may use two or more QTBT structures, such as one QTBT structure for the luminance component and another QTBT structure for both chrominance components (or two QTBT structures for respective chrominance components).

Video encoder 106 and video decoder 116 may be configured to use either quadtree partitioning per HEVC or QTBT partitioning according to JEM. For purposes of explanation, the description of the techniques of this disclosure is presented with respect to QTBT partitioning. However, it should be understood that the techniques of this disclosure may also be applied to video coders configured to use quadtree partitioning, or other types of partitioning as well.

In this disclosure, “N×N” and “N by N” may be used interchangeably to refer to the sample dimensions of a CU (or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may comprise N×M samples, where M is not necessarily equal to N.

Video encoder 106 encodes video data for CUs representing prediction and residual information, and other information, for the CU. The prediction information indicates how the CU is to be predicted in order to form a prediction block for the CU. The residual information generally represents sample-by-sample differences between samples of the CU prior to encoding and the prediction block.

To predict a CU, video encoder 106 may perform inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 106 may predict a CU using one or more motion vectors. Video encoder 106 may generally perform a motion search to identify a reference block that closely matches the CU, e.g., in terms of differences between the CU and the reference block. Video encoder 106 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 106 may predict the current CU using uni-directional prediction or bi-directional prediction.

JEM also provides an affine motion compensation mode, which may be considered an inter-prediction mode. In affine motion compensation mode, video encoder 106 may determine two or more motion vectors that represent non-translational motion, such as zoom in or out, rotation, perspective motion, or other irregular motion types.

To perform intra-prediction, video encoder 106 may select an intra-prediction mode. JEM provides sixty-seven intra-prediction modes, including various directional modes, as well as planar mode and DC mode. In general, video encoder 106 selects an intra-prediction mode that describes neighboring samples to a current CU from which to predict samples of the current CU. Such samples may generally be above, above and to the left, or to the left of the current CU in the same picture as the current CU, assuming video encoder 106 codes CTUs and CUs in raster scan order (left to right, top to bottom).

Video encoder 106 encodes data representing the prediction mode for a current CU. For example, for inter-prediction modes, video encoder 106 may encode data representing which of the various available inter-prediction modes is used, as well as motion information for the corresponding mode. For uni-directional or bi-directional inter-prediction, for example, video encoder 106 may encode motion vectors using advanced motion vector prediction (AMVP) or merge mode. Video encoder 106 may use similar modes to encode motion vectors for affine motion compensation mode.

Following prediction, such as intra-prediction or inter-prediction of a CU, video encoder 106 may calculate residual data for the CU. The residual data, such as a residual block, represents sample by sample differences between the CU and a prediction block for the CU, formed using the corresponding prediction mode. Video encoder 106 may apply one or more transforms to the residual block, to produce transformed data in a transform domain instead of the sample domain. For example, video encoder 106 may apply a discrete cosine transform (DCT), an integer transform, a wavelet transform, or a conceptually similar transform to residual video data. Additionally, video encoder 106 may apply a secondary transform following the first transform, such as a mode-dependent non-separable secondary transform (MDNSST), a signal dependent transform, a Karhunen-Loeve transform (KLT), or the like. Video encoder 106 produces transform coefficients following application of the one or more transforms.

As noted above, following any transforms to produce transform coefficients, video encoder 106 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, video encoder 106 may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 106 may utilize a predefined scan order to scan the quantized transform coefficients to produce a serialized vector that can be entropy encoded. In other examples, video encoder 106 may perform an adaptive scan. After scanning the quantized transform coefficients to form a one-dimensional vector, video encoder 106 may entropy encode the one-dimensional vector, e.g., according to context-adaptive binary arithmetic coding (CABAC). Video encoder 106 may also entropy encode syntax elements associated with the encoded video data for use by video decoder 116 in decoding the video data.

To perform CABAC, video encoder 106 may assign a context within a context model to a symbol to be transmitted. The context may relate to, for example, whether neighboring values of the symbol are non-zero or not. The probability determination may be based on a context assigned to the symbol.

In general, video decoder 116 performs a substantially similar, albeit reciprocal, process to that performed by video encoder 106 to decode encoded data. For example, video decoder 116 may decode syntax elements of a received bitstream using CABAC in a manner substantially similar to, albeit reciprocal to, the CABAC encoding process of video encoder 106. The syntax elements may define partitioning information of a CTU according to a corresponding QTBT structure to define CUs of the CTU, as well as prediction and residual information for each CTU. The residual information may include, for example, quantized transform coefficients. Video decoder 116 may inverse quantize and inverse transform coefficients of a received CU to reproduce a residual block for the CU. Video decoder 116 uses a signaled prediction mode (intra- or inter-prediction) to form a prediction block for the CU. Then, video decoder 116 combines the prediction block and the residual block (on a sample-by-sample basis) to reproduce the original CU. Video decoder 116 may perform additional processing, such as performing a deblocking process to reduce visual artifacts along block boundaries.

Video encoder 106 may further send syntax data, such as block-based syntax data, picture-based syntax data, and sequence-based syntax data, to video decoder 116, e.g., in a picture header, a block header, a slice header, or other syntax data, such as a sequence parameter set (SPS), picture parameter set (PPS), or video parameter set (VPS). Video decoder 116 may likewise decode such syntax data to determine how to decode corresponding video data.

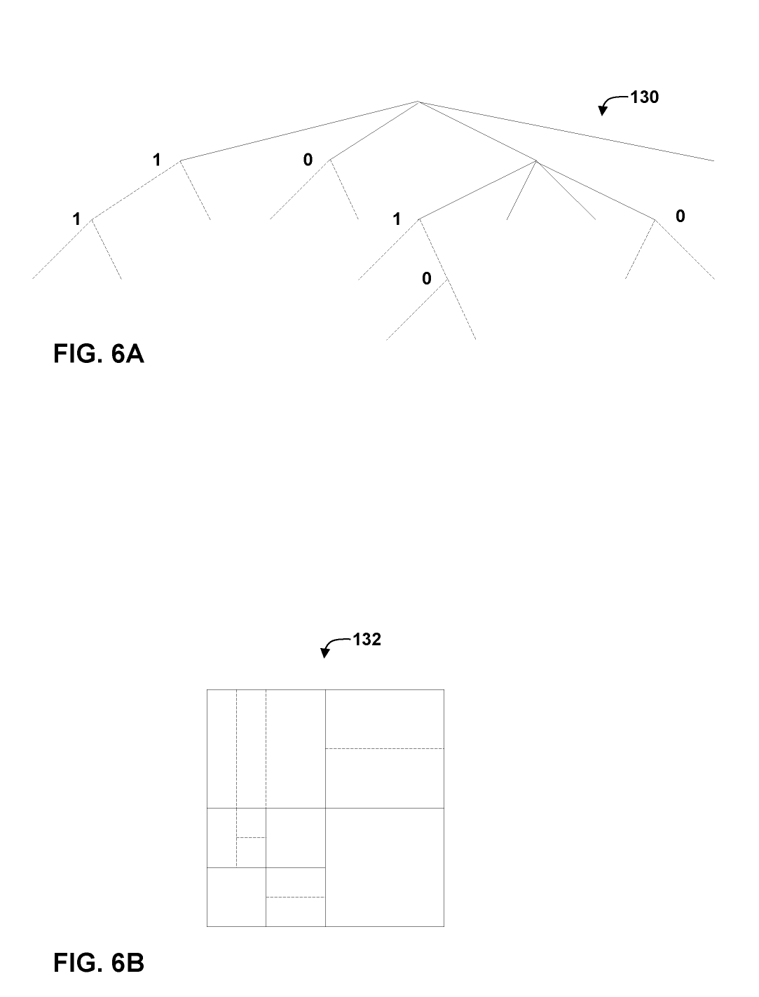

FIGS. 6A and 6B are conceptual diagrams illustrating an example quadtree binary tree (QTBT) structure 130, and a corresponding coding tree unit (CTU) 132. The solid lines represent quadtree splitting, and dotted lines indicate binary tree splitting. In each split (i.e., non-leaf) node of the binary tree, one flag is signaled to indicate which splitting type (i.e., horizontal or vertical) is used, where 0 indicates horizontal splitting and 1 indicates vertical splitting in this example. In some examples, splits can be non-symmetric, or include center-side-triple partitioning. For the quadtree splitting, there is no need to indicate the splitting type, since quadtree nodes split a block horizontally and vertically into 4 sub-blocks with equal size. Accordingly, video encoder 106 may encode, and video decoder 116 may decode, syntax elements (such as splitting information) for a region tree level of QTBT structure 130 (i.e., the solid lines) and syntax elements (such as splitting information) for a prediction tree level of QTBT structure 130 (i.e., the dashed lines). Video encoder 106 may encode, and video decoder 116 may decode, video data, such as prediction and transform data, for CUs represented by terminal leaf nodes of QTBT structure 130.

The CTU may be associated with parameters defining sizes of blocks corresponding to nodes at the first and second levels. These parameters may include a CTU size (representing a size of the CTU in samples), a minimum quadtree size (MinQTSize, representing a minimum allowed quadtree leaf node size), a maximum binary tree size (MaxBTSize, representing a maximum allowed binary tree root node size), a maximum binary tree depth (MaxBTDepth, representing a maximum allowed binary tree depth), and a minimum binary tree size (MinBTSize, representing the minimum allowed binary tree leaf node size).

The root node of the QTBT corresponding to the CTU may have four child nodes at the first level of the QTBT structure, each of which may be partitioned according to quadtree partitioning. That is, nodes of the first level are either leaf nodes (having no child nodes) or have four child nodes. If nodes of the first level are not larger than the maximum allowed binary tree root node size (MaxBTSize), they can be further partitioned by respective binary trees. The binary tree splitting of one node can be iterated until the nodes resulting from the split reach the minimum allowed binary tree leaf node size (MinBTSize) or the maximum allowed binary tree depth (MaxBTDepth). The binary tree leaf node is referred to as a coding unit (CU), which is used for prediction (e.g., intra-picture or inter-picture prediction) and transform, without any further partitioning. CUs may also be referred to as “video blocks” or “blocks.”

In one example of the QTBT partitioning structure, the CTU size is set to 128×128 (luma samples and two corresponding 64×64 chroma samples, Cb and Cr), the MinQTSize is set as 16×16, the MaxBTSize is set as 64×64, the MinBTSize (for both width and height) is set as 4, and the MaxBTDepth is set as 4. The quadtree partitioning is applied to the CTU first to generate quad-tree leaf nodes. The quadtree leaf nodes may have a size from 16×16 (i.e., the MinQTSize) to 128×128 (i.e., the CTU size). If the leaf quadtree node is 128×128, it will not be further split by the binary tree, since the size exceeds the MaxBTSize (i.e., 64×64, in this example). Otherwise, the leaf quadtree node will be further partitioned by the binary tree. Therefore, the quadtree leaf node is also the root node for the binary tree and has the binary tree depth as 0. When the binary tree depth reaches MaxBTDepth (4, in this example), no further splitting is permitted. When the binary tree node has width equal to MinBTSize (4, in this example), it implies no further horizontal splitting is permitted. Similarly, when the binary tree node has height equal to MinBTSize, it implies no further vertical splitting is permitted. The leaf nodes of the binary tree are named CUs, and are further processed according to prediction and transform without any further partitioning.

In JEM, for I slices, a luma-chroma-separated block partitioning structure is proposed. The luma component of one CTU (i.e., the luma CTB) is partitioned by a QTBT structure into luma coding blocks (CBs), and the two chroma components of that CTU (i.e., the two chroma CTBs) are partitioned by another QTBT structure into chroma CBs. For P and B slices, the block partitioning structure for luma and chroma is shared. That is, for P and B slices according to the JEM proposal, one CTU (including both luma and chroma) is partitioned by one QTBT structure into CUs.

Referring again to FIG. 5, this disclosure describes techniques for constructing motion candidate lists for prediction and coding of motion vectors, such as merge candidate lists and AVMP lists, based on a coding structure. Various example techniques are discussed below. Video encoder 106 and video decoder 116 may apply any or all of these techniques, alone or in any combination.

In some examples, video encoder 106 and video decoder 116 may treat a relative index of a split CU as an input parameter to this CU when encoding or decoding this CU. For example, the syntax table for a QTBT_tree structure can be designed as follows, where “blkIndex” is newly added relative to the QTBT structure of JEM (and in general, italicized elements are added relative to the QTBT structure of JEM):

| | |
|---|---|
| coding_QTBTtree( x0, y0, width, height, QDepth, BDepth, blkIndex) { | |
| . . . | |
| split_cu_type[ x0 ][ y0 ] | ae(v) |
| if( split_cu_type[ x0 ][ y0 ] ==Q-Tree) { | |
| coding_QTBTtree( x0, y0, width/2, height/2, QDepth + 1, BDepth, 0) | |
| coding_QTBTtree( x0 + width/2, y0, width/2, height/2, QDepth + 1, | |
| BDepth, 1) | |
| coding_QTBTtree( x0, y0+ height/2, width/2, height/2, QDepth + 1, | |
| BDepth, 2) | |
| coding_QTBTtree( x0 + width/2, y0 + | |
| height/2, width/2, height/2, QDepth + 1, BDepth, 3 ) | |
| } else if( split_cu_type[ x0 ][ y0 ] == B-Tree-H){ | |
| coding_QTBTtree( x0, y0, width, height/2, QDepth, BDepth + 1, 0) | |
| coding_QTBTtree( x0, y0+ height/2, width, height/2, QDepth, BDepth + | |
| 1, 1) | |
| } else if( split_cu_type[ x0 ][ y0 ] == B-Tree-V){ | |
| coding_QTBTtree( x0, y0, width/2, height, QDepth, BDepth + 1, 0) | |
| coding_QTBTtree( x0 + width/2, y0, width/2, height, QDepth, BDepth + | |
| 1, 1) | |
| } else if( split_cu_type[ x0 ][ y0 ] == NoSplit) | |
| coding_unit( x0, y0, width, height, QDepth, BDepth, blkIndex) | |
| . . . | |
| } | |

In this example, “blkIndex” represents an index to the relative position of a child block resulting from a parent block. In particular, “blkIndex” has a value of “0” for a left child block of a vertically split parent, a top child block of a horizontally split parent, or an upper-left child block of a quadtree-split parent, in this example. Likewise, in this example, “blkIndex” has a value of “1” for a right child block of a vertically split parent, a bottom child block of a horizontally split parent, or an upper-right child block of a quadtree-split parent. In this example, “blkIndex” has a value of “2” for a bottom-left child of a quadtree-split parent, and a value of “3” for a bottom-right child of a quadtree-split parent.

In some examples, video encoder 106 and video decoder 116 may treat a split way of a split CU as an input parameter to this CU when encoding or decoding the CU. For example, the syntax table for a QTBT structure can be designed as follows, where italicized elements are added relative to the QTBT structure of JEM:

| | |
|---|---|
| coding_QTBTtree( x0, y0, width, height, QDepth, BDepth, blkIndex, | |
| splitWay ) { | |
| . . . | |
| split_cu_type[ x0 ][ y0 ] | ae(v) |
| if( split_cu_type[ x0 ][ y0 ] ==Q-Tree) { | |
| coding_QTBTtree( x0, y0, width/2, height/2, QDepth + 1, BDepth, 0, Q- | |
| Tree) | |
| coding_QTBTtree( x0 + width/2, y0, width/2, height/2, QDepth + 1, | |
| BDepth, 1, Q-Tree ) | |
| coding_QTBTtree( x0, y0+ height/2, width/2, height/2, QDepth + 1, | |
| BDepth, 2, Q-Tree ) | |
| coding_QTBTtree( x0 + width/2, y0 + | |
| height/2, width/2, height/2, QDepth + 1, BDepth, 3, Q-Tree ) | |
| } else if( split_cu_type[ x0 ][ y0 ] == B-Tree-H){ | |
| coding_QTBTtree( x0, y0, width, height/2, QDepth, BDepth + 1, 0, B- | |
| Tree-H) | |
| coding_QTBTtree( x0, y0+ height/2, width, height/2, QDepth, BDepth + | |
| 1, 1, B-Tree-H) | |
| } else if( split_cu_type[ x0 ][ y0 ] == B-Tree-V){ | |
| coding_QTBTtree( x0, y0, width/2, height, QDepth, BDepth + 1, 0, B- | |
| Tree-V) | |
| coding_QTBTtree( x0 + width/2, y0, width/2, height, QDepth, BDepth + | |
| 1, 1, B-Tree-V ) | |
| } else if( split_cu_type[ x0 ][ y0 ] == NoSplit) | |
| coding_unit( x0, y0, width, height, QDepth, BDepth, blkIndex , | |
| splitWay ) | |
| . . . | |
| } | |

In this example, “blkIndex” is set as discussed above. In addition, “splitWay” has a value of “Q-Tree” for a quadtree-split parent, “B-Tree-H” for a horizontally split parent, and “B-Tree-V” for a vertically split parent.

In some examples, video encoder 106 and video decoder 116 may treat a split way of a CU as an output of this CU after encoding/decoding the CU. Video encoder 106 and video decoder 116 may then treat this output split way from the CU as an input parameter to a subsequent CU. For example, the syntax table for a QTBT tree structure can be designed as follows, where italicized text represents additions relative to the QTBT tree structure of JEM, and “preSplitWay” represents the input of split way from a previous CU:

| | |
|---|---|
| coding_QTBTtree( x0, y0, width, height, QDepth, BDepth, blkIndex, | |
| splitWay, preSplitWay ) { | |
| . . . | |
| split_cu_type[ x0 ][ y0 ] | ae(v) |
| if( split_cu_type[ x0 ][ y0 ] ==Q-Tree) { | |
| subSplitWay=coding_QTBTtree( x0, y0, width/2, height/2, QDepth + 1, | |
| BDepth, 0, Q-Tree, preSplitWay ) | |
| subSplitWay=coding_QTBTtree( x0 + | |
| width/2, y0, width/2, height/2, QDepth + 1, BDepth, 1, Q-Tree, subSplitWay) | |
| subSplitWay=coding_QTBTtree( x0, y0+ | |
| height/2, width/2, height/2, QDepth + 1, BDepth, 2, Q-Tree, subSplitWay ) | |
| subSplitWay=coding_QTBTtree( x0 + width/2, y0 + | |
| height/2, width/2, height/2, QDepth + 1, BDepth, 3, Q-Tree, subSplitWay ) | |
| } else if( split_cu_type[ x0 ][ y0 ] == B-Tree-H){ | |
| subSplitWay=coding_QTBTtree( x0, y0, width, height/2, QDepth, | |
| BDepth + 1, 0, B-Tree-H , preSplitWay ) | |
| subSplitWay=coding_QTBTtree( x0, y0+ | |
| height/2, width, height/2, QDepth, BDepth + 1, 1, B-Tree-H, subSplitWay ) | |
| } else if( split_cu_type[ x0 ][ y0 ] == B-Tree-V){ | |
| subSplitWay=coding_QTBTtree( x0, y0, width/2, height, QDepth, | |
| Bdepth + 1, 0, B-Tree-V , preSplitWay ) | |
| subSplitWay=coding_QTBTtree( x0 + | |
| width/2, y0, width/2, height, Qdepth, Bdepth + 1, 1, B-Tree-V, subSplitWay) | |
| } else if( split_cu_type[ x0 ][ y0 ] == NoSplit) | |
| coding_unit( x0, y0, width, height, Qdepth, Bdepth, blkIndex, | |
| splitWay,preSplitWay ) | |
| return split_cu_type[ x0 ][ y0 ] | |
| . . . | |
| } | |

In this example, blkIndex and splitWay may be set as discussed above, “preSplitWay” represents the value of “splitWay” of a previous block, and “subSplitWay” represents the output split way discussed above.

In the above examples, blkIndex, splitWay and preSplitWay can all be added to the QTBT_tree structure of JEM. Alternatively, any one of them can be added only. Alternatively, any combination of two of them can be added only. Thus, video encoder 106 and video decoder 116 may be configured to use any or all of blkIndex, splitWay, and/or preSplitWay, in any combination, as discussed above.

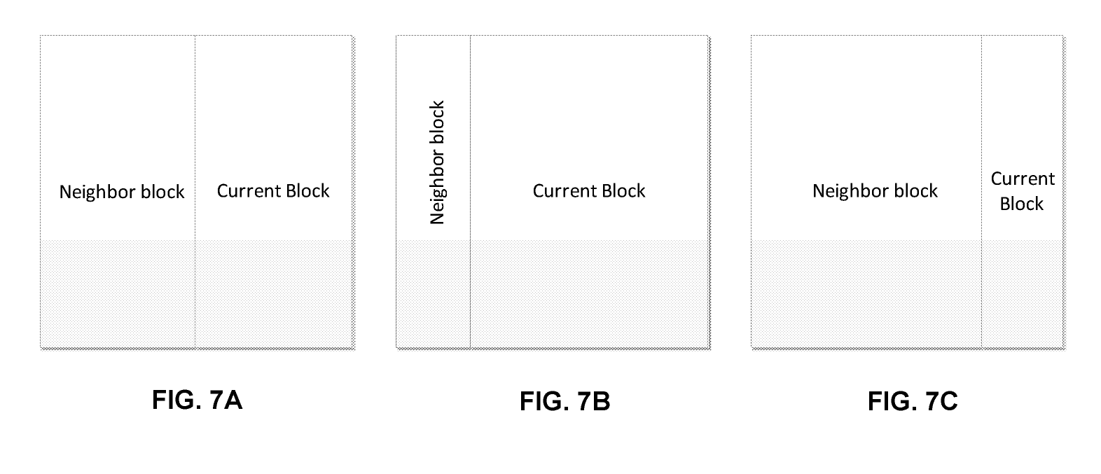

FIGS. 7A-7C are conceptual diagrams illustrating examples of situations in which video encoder 106 and video decoder 116 may avoid checking data of a neighboring child block to a current child block, where the neighboring child block may correspond to neighboring block A1 of FIG. 3 (that is, a left-neighboring block to the current block that is above a lowest left-neighboring block (e.g., block A0 of FIG. 3) to the current block). In particular, according to some examples of the techniques of this disclosure, video encoder 106 and video decoder 116 may avoid checking data of left-neighboring block A1 of FIG. 3 for the candidate list construction process if the following conditions are all true:
a. splitWay is equal to B-Tree-V, or any other split way to split a CU into two parts vertically;
b. blkIndex is equal to 1; and
c. preSplitWay is equal to NoSplit.

In the example of FIG. 7A, a parent block is vertically split into a neighbor block and a current block of equal size (B-Tree-V), satisfying part (a); blkIndex is “1” because the current block is on the right side of the parent block (per coding_QTBTtree(x0+width/2, y0, width/2, height, QDepth, BDepth+1, 1)), satisfying part (b); and preSplitWay is equal to NoSplit (because the neighbor block is not split), satisfying part (c).

In the example of FIG. 7B, a parent block is vertically split into a neighbor block and a current block of non-equal size (where the current block is larger horizontally than the neighbor block), satisfying part (a); blkIndex is “1” because the current block is on the right side of the parent block (per coding_QTBTtree(x0+width/2, y0, width/2, height, QDepth, BDepth+1, 1)), satisfying part (b); and preSplitWay is equal to NoSplit (because the neighbor block is not split), satisfying part (c).

In the example of FIG. 7C, a parent block is vertically split into a neighbor block and a current block of non-equal size (where the current block is smaller horizontally than the neighbor block), satisfying part (a); blkIndex is “1” because the current block is on the right side of the parent block (per coding_QTBTtree(x0+width/2, y0, width/2, height, QDepth, BDepth+1, 1)), satisfying part (b); and preSplitWay is equal to NoSplit (because the neighbor block is not split), satisfying part (c).

In some examples, if each of the conditions above is true, video encoder 106 and video decoder 116 may prune one or more candidates from the candidate list if the candidates have the same motion information as the motion information of neighboring block A1 if block A1 is not intra-coded. Video encoder 106 and video decoder 116 may determine that two pieces of motion information are the same if each of the following conditions are true:
a. The inter directions are the same. Inter direction can be List 0, List 1 or Bi-Prediction;
b. The two RefIndex[0]s are the same and two MV[0]s are the same, or the inter direction is equal to List1; and
c. The two RefIndex[1]s are the same and two MV[1]s are the same, or the inter direction is equal to List0.

In this example, RefIndex[0] and RefIndex[1] are the reference indices for List0 and List 1, respectively, and MV[0] and MV[1] are the motion vectors for List0 and List 1, respectively. In some examples, when checking each candidate, video encoder 106 and video decoder 116 may compare the motion information of the candidate to the motion information of neighboring block A1. Video encoder 106 and video decoder 116 may avoid appending the candidate into the candidate list if the candidate has the same motion information as neighboring block A1.

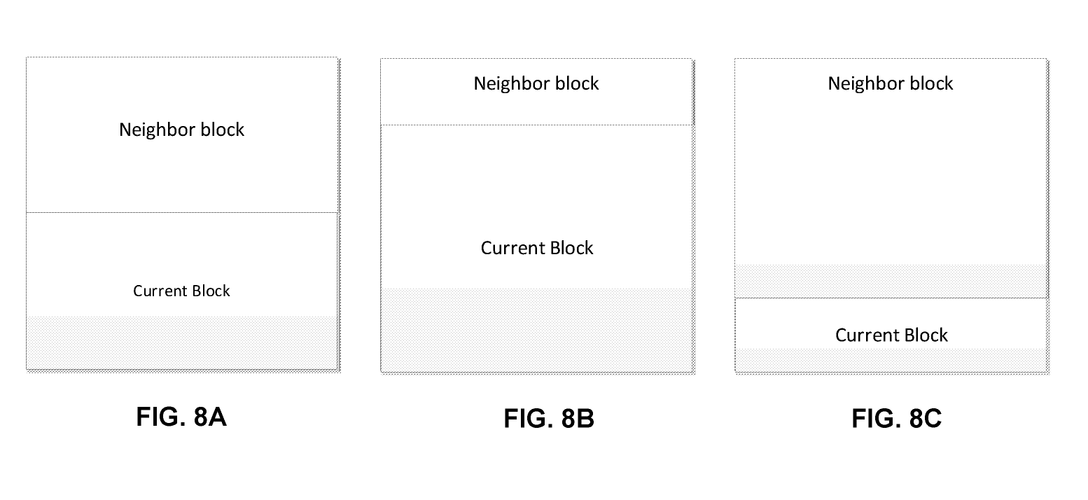

FIGS. 8A-8C are conceptual diagrams illustrating examples of situations in which video encoder 106 and video decoder 116 may avoid checking data of neighboring block B1 of FIG. 3 (that is, an above-right neighboring block to the current block). In particular, according to some examples of the techniques of this disclosure, video encoder 106 and video decoder 116 may avoid checking data of above-right neighboring block B1 of FIG. 3 for the candidate list construction process if the following conditions are all true:
a. splitWay is equal to B-Tree-H, or any other split way to split a CU into two parts horizontally;
b. blkIndex is equal to 1; and
c. preSplitWay is equal to NoSplit.

In the example of FIG. 8A, a parent block is horizontally split into a neighbor block and a current block of equal size (B-Tree-H), satisfying part (a); blkIndex is “1” because the current block is on the bottom side of the parent block (per coding_QTBTtree(x0, y0+height/2, width, height/2, QDepth, BDepth+1, 1)), satisfying part (b); and preSplitWay is equal to NoSplit (because the neighbor block is not split), satisfying part (c).

In the example of FIG. 8B, a parent block is horizontally split into a neighbor block and a current block of non-equal size (where the current block is larger vertically than the neighbor block), satisfying part (a); blkIndex is “1” because the current block is on the bottom side of the parent block (per coding_QTBTtree(x0, y0+height/2, width, height/2, QDepth, BDepth+1, 1)), satisfying part (b); and preSplitWay is equal to NoSplit (because the neighbor block is not split), satisfying part (c).

In the example of FIG. 8C, a parent block is horizontally split into a neighbor block and a current block of non-equal size (where the current block is smaller vertically than the neighbor block), satisfying part (a); blkIndex is “1” because the current block is on the bottom side of the parent block (per coding_QTBTtree(x0, y0+height/2, width, height/2, QDepth, BDepth+1, 1)), satisfying part (b); and preSplitWay is equal to NoSplit (because the neighbor block is not split), satisfying part (c).

In some examples, if each of the conditions above is true, video encoder 106 and video decoder 116 may prune any candidate in the candidate list having the same motion information as the motion information of neighboring block B1 if B1 is not intra-coded. In some examples, when checking each candidate, video encoder 106 and video decoder 116 may compare the motion information of the candidate with the motion information of neighboring block B1, and video encoder 106 and video decoder 116 may avoid appending the candidate into the candidate list if the candidate has the same motion information as neighboring block B1.

Referring again to FIG. 5, in some examples, video encoder 106 and video decoder 116 may avoid checking data of left-neighboring block A1 of FIG. 3 for the candidate list construction process for a current block if the following conditions are all true:
a. splitWay is equal to B-Tree-V, or any other split way to split a CU into two parts vertically;
b. blkIndex is equal to 1; and
c. BDepth of the neighboring block A1 is equal to BDepth of the current block.

In some examples, if each of the conditions above is true, video encoder 106 and video decoder 116 may prune any candidate in the candidate list having the same motion information as the motion information of neighboring block A1 if A1 is not intra-coded. In some examples, when checking each candidate, video encoder 106 and video decoder 116 may compare the motion information of the candidate to the motion information of neighboring block A1. Video encoder 106 and video decoder 116 may avoid appending the candidate into the candidate list if the candidate has the same motion information as neighboring block A1.

In some examples, video encoder 106 and video decoder 116 may avoid checking data of above-right neighboring block B1 of FIG. 3 for the candidate list construction process for a current block if the following conditions are all true:
a. splitWay is equal to B-Tree-H, or any other split way to split a CU into two parts horizontally;
b. blkIndex is equal to 1; and
c. BDepth of the neighboring block B1 is equal to BDepth of the current block.

In some examples, if each of the conditions above is true, video encoder 106 and video decoder 116 may prune any candidate in the candidate list having the same motion information as the motion information of neighboring block B1 if B1 is not intra-coded. In some examples, when checking each candidate, video encoder 106 and video decoder 116 may compare the motion information of the candidate with the motion information of neighboring block B1, and video encoder 106 and video decoder 116 may avoid appending the candidate into the candidate list if the candidate has the same motion information as neighboring block B1.

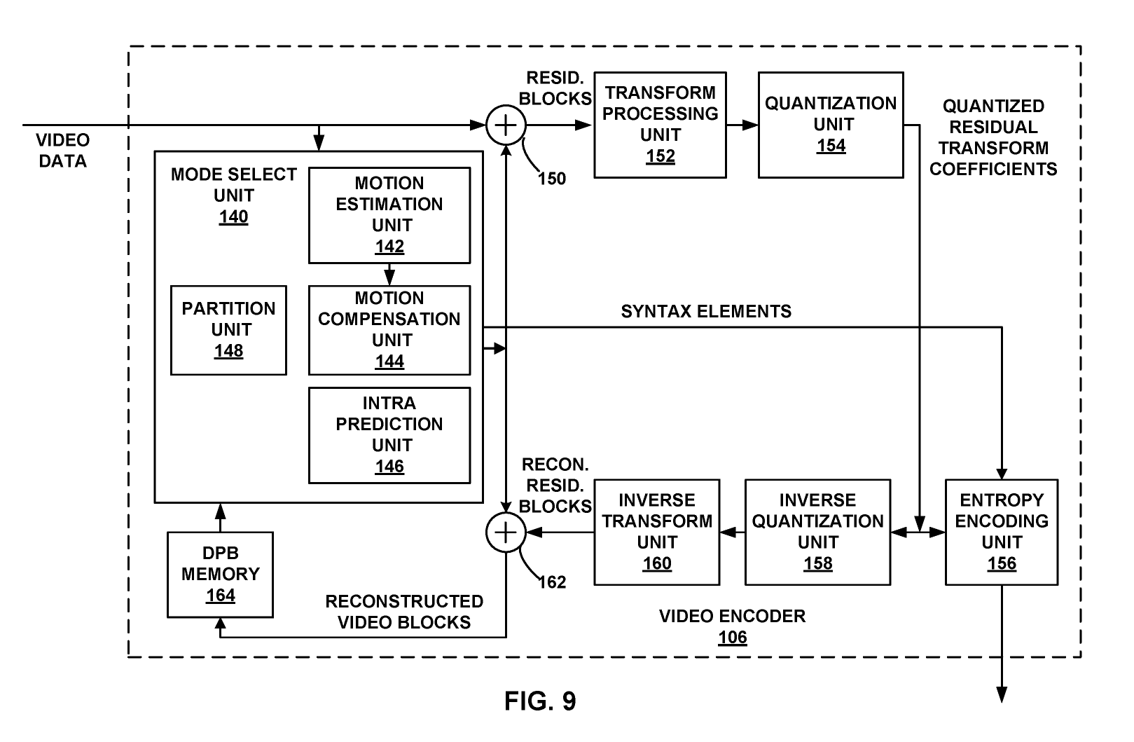

FIG. 9 is a block diagram illustrating an example of video encoder 106 that may implement techniques for coding motion information of this disclosure. Video encoder 106 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 9, video encoder 106 receives a current video block within a video frame to be encoded. In the example of FIG. 9, video encoder 106 includes mode select unit 140, decoded picture buffer (DPB) memory 164, summer 150, transform processing unit 152, quantization unit 154, and entropy encoding unit 156. Mode select unit 140, in turn, includes motion compensation unit 144, motion estimation unit 142, intra-prediction unit 146, and partition unit 148. For video block reconstruction, video encoder 106 also includes inverse quantization unit 158, inverse transform unit 160, and summer 162. A deblocking filter (not shown in FIG. 9) may also be included to filter block boundaries to remove blockiness artifacts from reconstructed video. If desired, the deblocking filter would typically filter the output of summer 162. Additional filters (in loop or post loop) may also be used in addition to the deblocking filter. Such filters are not shown for brevity, but if desired, may filter the output of summer 150 (as an in-loop filter).

During the encoding process, video encoder 106 receives a video frame or slice to be coded. The frame or slice may be divided into multiple video blocks. Motion estimation unit 142 and motion compensation unit 144 perform inter-predictive encoding of the received video block relative to one or more blocks in one or more reference frames to provide temporal prediction. Intra-prediction unit 146 may alternatively perform intra-predictive encoding of the received video block relative to one or more neighboring blocks in the same frame or slice as the block to be coded to provide spatial prediction. Video encoder 106 may perform multiple coding passes, e.g., to select an appropriate coding mode for each block of video data.

Moreover, partition unit 148 may partition blocks of video data into sub-blocks, based on evaluation of previous partitioning schemes in previous coding passes. For example, partition unit 148 may initially partition a frame or slice into CTUs, and partition each of the CTUs into sub-CUs based on rate-distortion analysis (e.g., rate-distortion optimization). Mode select unit 140 may further produce a QTBT data structure indicative of partitioning of a CTU into CUs.

Mode select unit 140 may select one of the prediction modes, intra or inter, e.g., based on error results, and provides the resulting prediction block to summer 150 to generate residual data and to summer 162 to reconstruct the encoded block for use as a reference frame. Mode select unit 140 also provides syntax elements, such as motion vectors, intra-mode indicators, partition information, and other such syntax information, to entropy encoding unit 156.

Motion estimation unit 142 and motion compensation unit 144 may be highly integrated, but are illustrated separately for conceptual purposes. Motion estimation, performed by motion estimation unit 142, is the process of generating motion vectors, which estimate motion for video blocks. A motion vector, for example, may indicate the displacement of a CU of a video block within a current video frame or picture relative to a prediction block within a reference frame (or other coded unit) relative to the current block being coded within the current frame (or other coded unit). A prediction block is a block that is found to closely match the block to be coded, in terms of sample difference, which may be determined by sum of absolute difference (SAD), sum of square difference (SSD), or other difference metrics. In some examples, video encoder 106 may calculate values for sub-integer sample positions of reference pictures stored in DPB memory 164. For example, video encoder 106 may interpolate values of one-quarter sample positions, one-eighth sample positions, or other fractional sample positions of the reference picture. Therefore, motion estimation unit 142 may perform a motion search relative to the full sample positions and fractional sample positions and output a motion vector with fractional sample precision.

Motion estimation unit 142 calculates a motion vector for a CU in an inter-coded slice by comparing the position of the CU to the position of a reference block of a reference picture. The reference picture may be selected from a first reference picture list (List 0) or a second reference picture list (List 1), each of which identify one or more reference pictures stored in DPB memory 164. In some examples, the motion vectors may represent translational motion, while in other examples (such as in affine motion compensation), the motion vectors may represent other types of motion, such as zoom, rotation, perspective motion, or other irregular motion types. Motion estimation unit 142 sends the calculated motion vector to entropy encoding unit 156 and motion compensation unit 144.

In accordance with the techniques of this disclosure, when a current block is a current child block of a parent block that also includes a neighboring child block (the child blocks corresponding to leaf nodes of a partition tree structure, such as the QTBT structure of FIG. 6A), motion estimation unit 142 and motion compensation unit 144 may avoid including motion information of the neighboring child block in a motion candidate list for the current child block. That is, the motion candidate list may omit data representative of a motion vector for the neighboring child block. Motion estimation unit 142 may determine a candidate index identifying a motion vector to be used to predict the current child block and provide the candidate index to entropy encoding unit 156 as a syntax element to be entropy encoded. Video encoder 106 may be configured to generate the motion candidate list using any of the various techniques discussed above, e.g., with respect to FIGS. 7 and 8 and with respect to the various coding QTBTtree syntax tables above.

Motion compensation, performed by motion compensation unit 144, may involve fetching or generating the prediction block based on the motion vector determined by motion estimation unit 142. Again, motion estimation unit 142 and motion compensation unit 144 may be functionally integrated, in some examples. Upon receiving the motion vector for the CU, motion compensation unit 144 may locate a reference block to which the motion vector points in one of the reference picture lists, and generate the prediction block from the reference block. Additionally, motion compensation unit 144 may construct a motion candidate list according to any of the techniques of this disclosure to encode the motion vector.

Summer 150 forms a residual video block by subtracting sample values of the prediction block from the sample values of the current video block being coded, forming sample difference values, as discussed below. In general, motion estimation unit 142 performs motion estimation relative to luma components, and motion compensation unit 144 uses motion vectors calculated based on the luma components for both chroma components and luma components. Mode select unit 140 may also generate syntax elements associated with the video blocks and the video slice for use by video decoder 116 in decoding the video blocks of the video slice.

Intra-prediction unit 146 may intra-predict a current block, as an alternative to the inter-prediction performed by motion estimation unit 142 and motion compensation unit 144, as described above. In particular, intra-prediction unit 146 may determine an intra-prediction mode to use to predict a current block. In some examples, intra-prediction unit 146 may encode a current block using various intra-prediction modes, e.g., during separate encoding passes, and mode select unit 140 may select an appropriate intra-prediction mode to use from the tested modes.

For example, mode select unit 140 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 146 may calculate ratios from the distortions and rates for the various encoded blocks to determine which intra-prediction mode exhibits the best rate-distortion value for the block.

After selecting an intra-prediction mode for a block, intra-prediction unit 146 may provide information indicative of the selected intra-prediction mode for the block to entropy encoding unit 156. Entropy encoding unit 156 may encode the information indicating the selected intra-prediction mode. Video encoder 106 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 106 forms a residual video block by subtracting the prediction data from mode select unit 140 from the original video block being coded. Summer 150 represents the component or components that perform this subtraction operation. Transform processing unit 152 applies a transform, such as a discrete cosine transform (DCT) or a conceptually similar transform, to the residual block, producing a video block comprising transform coefficient values. Wavelet transforms, integer transforms, sub-band transforms, discrete sine transforms (DSTs), or other types of transforms could be used instead of a DCT. In any case, transform processing unit 152 applies the transform to the residual block, producing a block of transform coefficients. The transform may convert the residual information from a sample domain to a transform domain, such as a frequency domain. Transform processing unit 152 may send the resulting transform coefficients to quantization unit 154. Quantization unit 154 quantizes the transform coefficients to further reduce bit rate. The quantization process may reduce the bit depth associated with some or all of the coefficients. The degree of quantization may be modified by adjusting a quantization parameter.

Following quantization, entropy encoding unit 156 entropy encodes the quantized transform coefficients. For example, entropy encoding unit 156 may perform context adaptive binary arithmetic coding (CABAC) or another entropy coding technique. In the case of context-based entropy coding, context may be based on neighboring blocks. Following the entropy coding by entropy encoding unit 156, the encoded bitstream may be transmitted to another device (e.g., video decoder 116) or archived for later transmission or retrieval.

Inverse quantization unit 158 and inverse transform unit 160 apply inverse quantization and inverse transformation, respectively, to reconstruct the residual block in the sample domain. In particular, summer 162 adds the reconstructed residual block to the motion compensated prediction block earlier produced by motion compensation unit 144 or intra-prediction unit 146 to produce a reconstructed video block for storage in DPB memory 164. The reconstructed video block may be used by motion estimation unit 142 and motion compensation unit 144 as a reference block to inter-code a block in a subsequent video frame.

Video encoder 106 of FIG. 9 represents an example of a video encoder configured to encode video data, including a memory (e.g., DPB memory 164) comprising circuitry configured to store video data; and one or more processors (e.g., mode select unit 140, motion estimation unit 142, motion compensation unit 144, and entropy encoding unit 156) implemented in circuitry and configured to partition a parent block of the video data into a neighboring child block and a current child block, wherein the neighboring child block and the current child block correspond to leaf nodes of a partition tree structure for the parent block, in response to partitioning the parent block into the neighboring child block and the current child block, construct a motion candidate list for the current child block including a plurality of motion vector candidates such that the plurality of motion vector candidates omit data representative of a motion vector for the neighboring child block, and encode motion information of the current child block using one of the plurality of motion vector candidates.

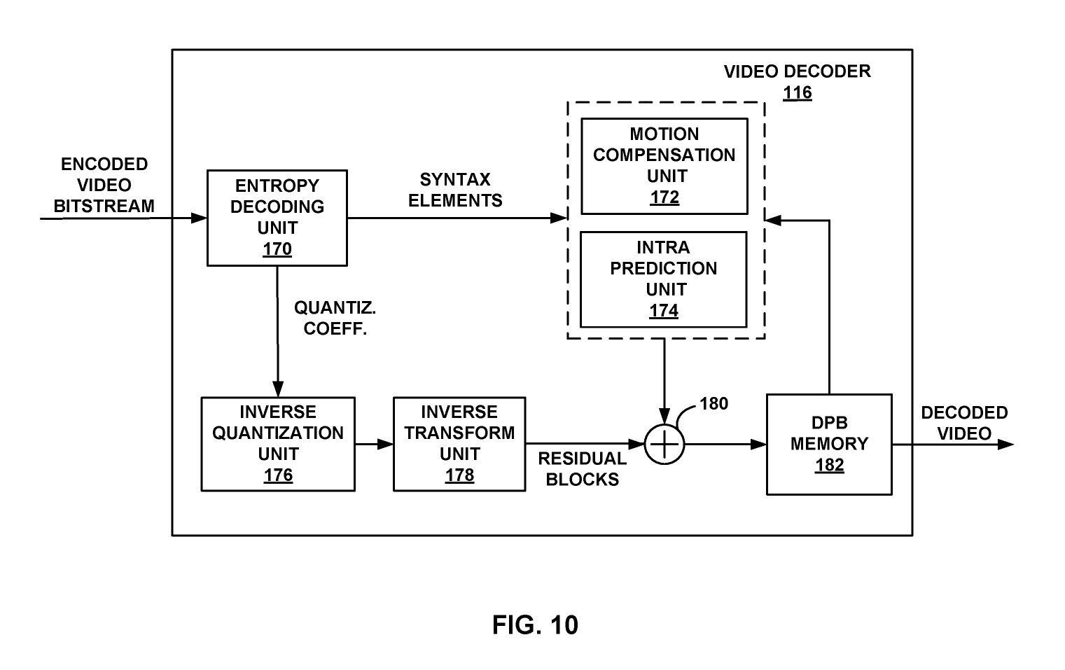

FIG. 10 is a block diagram illustrating an example of video decoder 116 that may implement techniques for coding motion information of this disclosure. In the example of FIG. 10, video decoder 116 includes an entropy decoding unit 170, motion compensation unit 172, intra-prediction unit 174, inverse quantization unit 176, inverse transformation unit 178, decoded picture buffer (DPB) memory 182, and summer 180. Video decoder 116 may, in some examples, perform a decoding pass generally reciprocal to the encoding pass described with respect to video encoder 106 (FIG. 9). Motion compensation unit 172 may generate prediction data based on motion vectors received from entropy decoding unit 170, while intra-prediction unit 174 may generate prediction data based on intra-prediction mode indicators received from entropy decoding unit 170.

Motion compensation unit 172 may construct a motion candidate list according to any of the techniques of this disclosure to decode the motion vector. In particular, the motion candidate list may omit data representative of a motion vector for a neighboring child block to a current child block of a parent block, as discussed above. Motion compensation unit 172 may determine a motion vector for the current child block using a candidate index into the motion candidate list. Video decoder 116 may be configured to generate the motion candidate list using any of the various techniques discussed above, e.g., with respect to FIGS. 7 and 8 and with respect to the various coding_QTBTtree syntax tables above.

During the decoding process, video decoder 116 receives an encoded video bitstream that represents video blocks of an encoded video slice and associated syntax elements from video encoder 106. Entropy decoding unit 170 of video decoder 116 entropy decodes the bitstream to generate quantized coefficients, motion vectors or intra-prediction mode indicators, and other syntax elements. Entropy decoding unit 170 forwards the motion vectors to and other syntax elements to motion compensation unit 172. Video decoder 116 may receive the syntax elements at the video slice level and/or the video block level.

When the video slice is coded as an intra-coded (I) slice, intra prediction unit 174 may generate prediction data for a video block of the current video slice based on a signaled intra prediction mode and data from previously decoded blocks of the current frame or picture. When the video frame is coded as an inter-coded (i.e., B or P) slice, motion compensation unit 172 produces prediction blocks for a video block of the current video slice based on the motion vectors and other syntax elements received from entropy decoding unit 170. The prediction blocks may be produced from one of the reference pictures within one of the reference picture lists.

Video decoder 116 may construct the reference picture lists, List 0 and List 1, using default construction techniques based on reference pictures stored in DPB memory 182. Motion compensation unit 172 determines prediction information for a video block of the current video slice by parsing the motion vectors and other syntax elements, and uses the prediction information to produce the prediction blocks for the current video block being decoded. For example, motion compensation unit 172 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 172 may also perform interpolation based on interpolation filters. Motion compensation unit 172 may use interpolation filters as used by video encoder 106 during encoding of the video blocks to calculate interpolated values for sub-integer samples of reference blocks. In this case, motion compensation unit 172 may determine the interpolation filters used by video encoder 106 from the received syntax elements and use the interpolation filters to produce prediction blocks.

Inverse quantization unit 176 inverse quantizes, i.e., de-quantizes, the quantized transform coefficients provided in the bitstream and decoded by entropy decoding unit 170. The inverse quantization process may include use of a quantization parameter QP_{Y} calculated by video decoder 116 for each video block in the video slice to determine a degree of quantization and, likewise, a degree of inverse quantization that should be applied.

Inverse transform unit 178 applies an inverse transform, e.g., an inverse DCT, an inverse integer transform, or a conceptually similar inverse transform process, to the transform coefficients in order to produce residual blocks in the sample domain.

After motion compensation unit 172 generates the prediction block for the current video block based on the motion vectors and other syntax elements, video decoder 116 forms a decoded video block by summing samples of the residual blocks from inverse transform unit 178 with the corresponding (e.g., co-located) samples of prediction blocks generated by motion compensation unit 172. Summer 180 represents the component or components that perform this summation operation. If desired, a deblocking filter may also be applied to filter the decoded blocks in order to remove blockiness artifacts. Other loop filters (either in the coding loop or after the coding loop) may also be used to smooth sample transitions, or otherwise improve the video quality. The decoded video blocks in a given frame or picture are then stored in DPB memory 182, which stores reference pictures used for subsequent motion compensation. DPB memory 182 also stores decoded video for later presentation on a display device, such as display device 114 of FIG. 5.

Video decoder 116 of FIG. 10 represents an example of a video decoder configured to decode video data, including a memory (e.g., DPB memory 182) comprising circuitry configured to store video data; and one or more processors (e.g., entropy decoding unit 170 and motion compensation unit 172) implemented in circuitry and configured to partition a parent block of the video data into a neighboring child block and a current child block, wherein the neighboring child block and the current child block correspond to leaf nodes of a partition tree structure for the parent block, in response to partitioning the parent block into the neighboring child block and the current child block, construct a motion candidate list for the current child block including a plurality of motion vector candidates such that the plurality of motion vector candidates omit data representative of a motion vector for the neighboring child block, and code motion information of the current child block using one of the plurality of motion vector candidates.

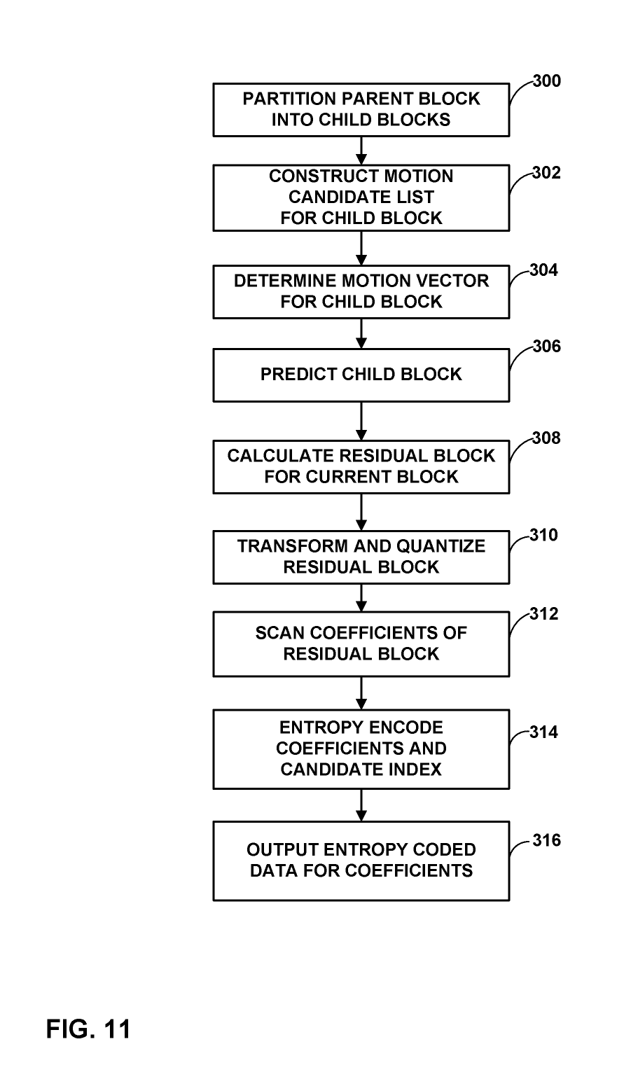

FIG. 11 is a flowchart illustrating an example method for encoding a current block according to the techniques of this disclosure. The current block may comprise a current CU. Although described with respect to video encoder 106 (FIGS. 5 and 9), it should be understood that other devices may be configured to perform a method similar to that of FIG. 11.

In this example, video encoder 106 initially partitions a parent block into child blocks (300), e.g., a neighboring child block and a current child block as shown in FIGS. 7A-7C. For example, video encoder 106 may test a variety of partitioning methods and determine that partitioning the parent block into the child blocks yields a best rate-distortion performance. The child blocks (e.g., the neighboring block and the current child block) may correspond to leaf nodes of a partition tree structure for the parent block. The partition tree structure may correspond to, for example, a QTBT structure, such as that shown in FIG. 2A.

Video encoder 106 then constructs a motion candidate list for one of the child blocks (302), such as the current child block. As explained above, the motion candidate list includes motion vector candidates of neighboring blocks to the current child block. However, in accordance with the techniques of this disclosure, video encoder 106 avoids including motion information of the neighboring child block in the motion candidate list for the current child block. That is, this disclosure recognizes that, if the motion information for the child blocks is the same, then partitioning the parent block into the child blocks would not occur. As such, when the parent block is partitioned into the child blocks, this disclosure recognizes that the motion information for the child blocks should be different, such that the motion information for the neighboring child block should not be used to predict the current child block. In other words, the motion candidate list omits data representative of a motion vector for the neighboring child block. In this manner, these techniques may save processing operations that may otherwise occur in processing motion information of the neighboring child block, thereby potentially improving operation of video encoder 106.

Video encoder 106 may then determine a motion vector for the current child block (304) from the motion candidate list. For example, video encoder 106 may determine which of the motion vectors in the motion candidate list yields a best rate-distortion performance for encoding the current child block. Video encoder 106 may then predict the current block using the determined motion vector (306). For example, video encoder 106 may form a prediction block for the current block using the determined motion vector. That is, motion compensation unit 144 may construct the prediction block from a reference block identified by the motion vector, as discussed above.

Video encoder 106 may then calculate a residual block for the current block (308). To calculate the residual block, video encoder 106 (and, in particular, summer 150) may calculate a difference between the original, uncoded block and the prediction block for the current block. Video encoder 106 may then transform and quantize coefficients of the residual block (310). Next, video encoder 106 may scan the quantized transform coefficients of the residual block (312). During the scan, or following the scan, video encoder 106 may entropy encode the coefficients, as well as a candidate index (314). In particular, the candidate index may identify the motion vector in the motion candidate list used to predict the current child block. Video encoder 106 may encode the coefficients and the candidate index using CABAC. Video encoder 106 may then output the entropy coded data of the block (316).

In this manner, the method of FIG. 11 represents an example of a method including partitioning a parent block of video data into a neighboring child block and a current child block, wherein the neighboring child block and the current child block correspond to leaf nodes of a partition tree structure for the parent block, in response to partitioning the parent block into the neighboring child block and the current child block, constructing a motion candidate list for the current child block including a plurality of motion vector candidates such that the plurality of motion vector candidates omit data representative of a motion vector for the neighboring child block, and coding motion information of the current child block using one of the plurality of motion vector candidates. In particular, in the example of FIG. 11, the method includes encoding the motion information of the current child block. In this example, the method also includes forming a prediction block for the current child block using the motion information, forming a residual block for the current child block comprising differences between samples of the current child block and corresponding samples of the prediction block, and encoding the residual block.

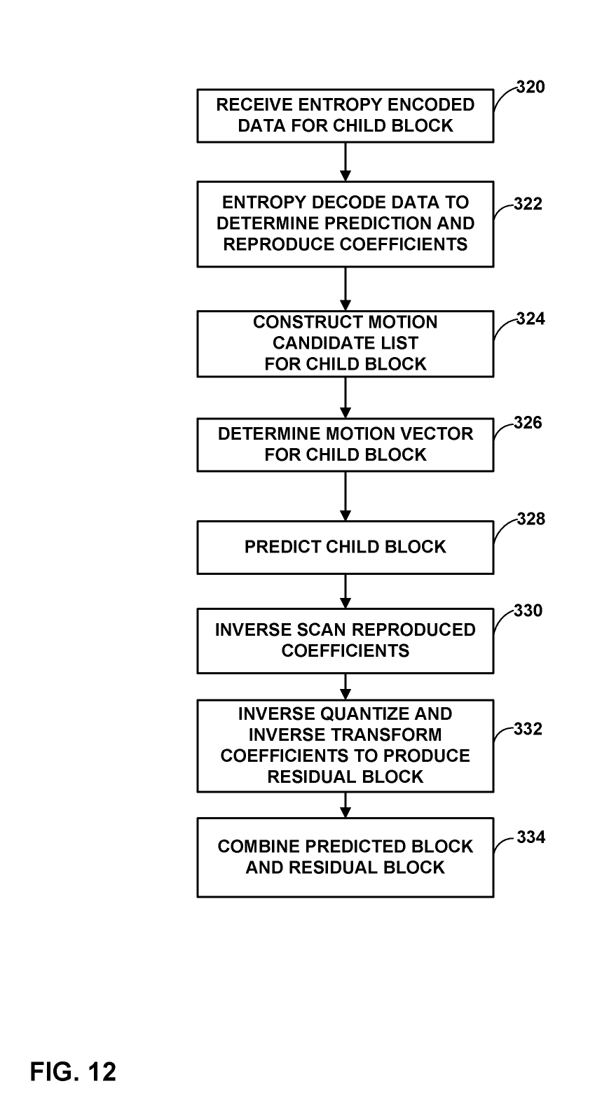

FIG. 12 is a flowchart illustrating an example method for decoding a current block of video data according to the techniques of this disclosure. The current block may comprise a current CU. Although described with respect to video decoder 116 (FIGS. 5 and 10), it should be understood that other devices may be configured to perform a method similar to that of FIG. 12.

Video decoder 116 may receive entropy encoded data for the current block (320), such as entropy encoded prediction information and entropy encoded data for coefficients of a residual block corresponding to the current block. The current block in this example corresponds to a current child block of a parent block, where the parent block also includes a neighboring child block to the current child block. Furthermore, the neighboring child block and the current child block may correspond to leaf nodes of a partition tree structure for the parent block, such as a QTBT structure.

Video decoder 116 may entropy decode the entropy encoded data to determine prediction information for the current block and to reproduce coefficients of the residual block (322). In this example, the prediction information may include a candidate index into a motion candidate list for the current block. Accordingly, video decoder 116 may construct the motion candidate list for the child block (324). In particular, as explained above, the motion candidate list includes motion vector candidates of neighboring blocks to the current child block. However, in accordance with the techniques of this disclosure, video decoder 116 avoids including motion information of the neighboring child block in the motion candidate list for the current child block. That is, when the parent block is partitioned into the child blocks, this disclosure recognizes that the motion information for the child blocks should be different, such that the motion information for the neighboring child block should not be used to predict the current child block. In other words, video decoder 116 may construct the motion candidate list to omit data representative of a motion vector for the neighboring child block. In this manner, these techniques may save processing operations that may otherwise occur in processing motion information of the neighboring child block, thereby potentially improving operation of video decoder 116.

Video decoder 116 may then determine a motion vector for the current child block from the motion candidate list (326). For example, video decoder 116 may use the decoded candidate index to identify a motion vector in the motion candidate list corresponding to the candidate index. Video decoder 116 may then predict the current child block (328) using the determined motion vector according to inter-prediction. For example, motion compensation unit 172 may generate a prediction block using a reference block identified by the motion vector, as explained above. Video decoder 116 may then inverse scan the reproduced coefficients (330), to create a block of quantized transform coefficients. Video decoder 116 may then inverse quantize and inverse transform the coefficients to produce a residual block (332). Video decoder 116 may ultimately decode the current block by combining the prediction block and the residual block (334). That is, video decoder 116 may add samples of the prediction block to corresponding (e.g., co-located) samples of the residual block to decode and reconstruct the current child block.

In this manner, the method of FIG. 12 represents an example of a method including partitioning a parent block of video data into a neighboring child block and a current child block, wherein the neighboring child block and the current child block correspond to leaf nodes of a partition tree structure for the parent block, in response to partitioning the parent block into the neighboring child block and the current child block, constructing a motion candidate list for the current child block including a plurality of motion vector candidates such that the plurality of motion vector candidates omit data representative of a motion vector for the neighboring child block, and coding motion information of the current child block using one of the plurality of motion vector candidates. In particular, in the example of FIG. 12, the method includes decoding the motion information of the current child block. In this example, the method also includes forming a prediction block for the current child block using the motion information, decoding a residual block for the current child block, and adding samples of the prediction block to corresponding samples of the residual block to reproduce the current child block.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
partitioning a parent block of video data into a neighboring child block and a current child block, wherein the neighboring child block and the current child block correspond to leaf nodes of a partition tree structure for the parent block;
in response to partitioning the parent block into the neighboring child block and the current child block, constructing a motion candidate list for the current child block including a plurality of motion vector candidates such that the plurality of motion vector candidates omit data representative of a motion vector for the neighboring child block; and
coding motion information of the current child block using one of the plurality of motion vector candidates.

2. The method of claim 1, further comprising determining that the neighboring child block and the current child block are partitions of the parent block using a value for a block index of the current child block, the value for the block index representing a relative location of the current child block in the parent block.

3. The method of claim 1, further comprising determining that the neighboring child block and the current child block are partitions of the parent block using a value for a split way element of the current child block, the value for the split way element representing a manner in which the parent block is split into the neighboring block and the child block.

4. The method of claim 1, further comprising determining that the neighboring child block and the current child block are partitions of the parent block using a value for a split way element of a previous child block, the value for the split way element representing a manner in which a parent block for the previous child block is split to include the previous child block.

5. The method of claim 1, wherein constructing the motion candidate list comprises avoiding checking motion information of a left-neighboring block to the current child block, the left-neighboring block being above a lowest left-neighboring block to the current child block, when a value of a split way element of the current child block indicates that the parent block is vertically split into two parts, when a value of a block index indicates that the current child block is to the right of the neighboring child block, and when a value of a previous split way element for a previous child block indicates that the previous child block is not split.

6. The method of claim 1, wherein constructing the motion candidate list comprises avoiding checking motion information of a left-neighboring block when a value of a split way element of the current child block indicates that the parent block is vertically split into two parts, a value of a block index indicates that the current child block is to the right of the neighboring child block, and when a bi-tree partition depth of the left-neighboring block is equal to a bi-tree partition depth of the current child block.

7. The method of claim 6, further comprising avoiding inclusion in the motion candidate list of any candidate having the motion information of the left-neighboring block when the value of the split way element of the current child block indicates that the parent block is vertically split into two parts, the value of the block index indicates that the current child block is to the right of the neighboring child block, and when the value of the previous split way element for the previous child block indicates that the previous child block is not split.

8. The method of claim 1, wherein constructing the motion candidate list comprises avoiding checking motion information of an above-right neighboring block to the current child block when a value of a split way element of the current child block indicates that the parent block is horizontally split into two parts, a value of a block index indicates that the current child block is below the neighboring child block, and when a value of a previous split way element for a previous child block indicates that the previous child block is not split.

9. The method of claim 1, wherein constructing the motion candidate list comprises avoiding checking motion information of an above-right neighboring block to the current child block when a value of a split way element of the current child block indicates that the parent block is horizontally split into two parts, a value of a block index indicates that the current child block is below the neighboring child block, and when a bi-tree partition depth of a left-neighboring block is equal to a bi-tree partition depth of the current child block.

10. The method of claim 9, further comprising avoiding inclusion in the motion candidate list of any candidate having the motion information of the left-neighboring block when the value of the split way element of the current child block indicates that the parent block is vertically split into two parts, the value of the block index indicates that the current child block is to the right of the neighboring child block, and when the value of the previous split way element for the previous child block indicates that the previous child block is not split.

11. The method of claim 1, wherein coding the motion information comprises decoding the motion information, the method further comprising:
forming a prediction block for the current child block using the motion information;
decoding a residual block for the current child block; and
adding samples of the prediction block to corresponding samples of the residual block to reproduce the current child block.

12. The method of claim 1, wherein coding the motion information comprises encoding the motion information, the method further comprising:
forming a prediction block for the current child block using the motion information;
forming a residual block for the current child block comprising differences between samples of the current child block and corresponding samples of the prediction block; and
encoding the residual block.

13. A device for coding video data, the device comprising:
a memory comprising circuitry configured to store video data; and
one or more processors implemented in circuitry and configured to:
partition a parent block of the video data into a neighboring child block and a current child block, wherein the neighboring child block and the current child block correspond to leaf nodes of a partition tree structure for the parent block;
in response to partitioning the parent block into the neighboring child block and the current child block, construct a motion candidate list for the current child block including a plurality of motion vector candidates such that the plurality of motion vector candidates omit data representative of a motion vector for the neighboring child block; and
code motion information of the current child block using one of the plurality of motion vector candidates.

14. The device of claim 13, wherein the one or more processors are further configured to determine that the neighboring child block and the current child block are partitions of the parent block using a value for a block index of the current child block, the value for the block index representing a relative location of the current child block in the parent block.

15. The device of claim 13, wherein the one or more processors are further configured to determine that the neighboring child block and the current child block are partitions of the parent block using a value for a split way element of the current child block, the value for the split way element representing a manner in which the parent block is split into the neighboring block and the child block.

16. The device of claim 13, wherein the one or more processors are further configured to determine that the neighboring child block and the current child block are partitions of the parent block using a value for a split way element of a previous child block, the value for the split way element representing a manner in which a parent block for the previous child block is split to include the previous child block.

17. The device of claim 13, wherein to construct the motion candidate list, the one or more processors are configured to avoid checking motion information of a left-neighboring block to the current child block, a left-neighboring block being above a lowest left-neighboring block to the current child block, when a value of a split way element of the current child block indicates that the parent block is vertically split into two parts, when a value of a block index indicates that the current child block is to the right of the neighboring child block, and when a value of a previous split way element for a previous child block indicates that the previous child block is not split.

18. The device of claim 13, wherein to construct the motion candidate list, the one or more processors are configured to avoid checking motion information of a left-neighboring block when a value of a split way element of the current child block indicates that the parent block is vertically split into two parts, a value of a block index indicates that the current child block is to the right of the neighboring child block, and when a bi-tree partition depth of the left-neighboring block is equal to a bi-tree partition depth of the current child block.

19. The device of claim 13, wherein to construct the motion candidate list, the one or more processors are configured to avoid checking motion information of an above-right neighboring block to the current child block when a value of a split way element of the current child block indicates that the parent block is horizontally split into two parts, a value of a block index indicates that the current child block is below the neighboring child block, and when a value of a previous split way element for a previous child block indicates that the previous child block is not split.

20. The device of claim 13, wherein to construct the motion candidate list, the one or more processors are configured to avoid checking motion information of an above-right neighboring block to the current child block when a value of a split way element of the current child block indicates that the parent block is horizontally split into two parts, a value of a block index indicates that the current child block is below the neighboring child block, and when a bi-tree partition depth of a left-neighboring block is equal to a bi-tree partition depth of the current child block.

21. The device of claim 13, further comprising a display configured to display decoded video data.

22. The device of claim 13, wherein the device comprises one or more of a camera, a computer, a mobile device, a broadcast receiver device, or a set-top box.

23. The device of claim 13, wherein the one or more processors comprise a video decoder configured to decode the motion information and further configured to:
form a prediction block for the current child block using the motion information;
decode a residual block for the current child block; and
add samples of the prediction block to corresponding samples of the residual block to reproduce the current child block.

24. The device of claim 13, wherein the one or more processors comprise a video encoder configured to encode the motion information and further configured to:
form a prediction block for the current child block using the motion information;
form a residual block for the current child block comprising differences between samples of the current child block and corresponding samples of the prediction block; and
encode the residual block.

25. A computer-readable storage medium having stored thereon instructions that, when executed, cause a processor to:
partition a parent block of video data into a neighboring child block and a current child block, wherein the neighboring child block and the current child block correspond to leaf nodes of a partition tree structure for the parent block;
in response to partitioning the parent block into the neighboring child block and the current child block, construct a motion candidate list for the current child block including a plurality of motion vector candidates such that the plurality of motion vector candidates omit data representative of a motion vector for the neighboring child block; and
code motion information of the current child block using one of the plurality of motion vector candidates.

26. The computer-readable storage medium of claim 25, further comprising instructions that cause the processor to determine that the neighboring child block and the current child block are partitions of the parent block using a value for a block index of the current child block, the value for the block index representing a relative location of the current child block in the parent block.

27. The computer-readable storage medium of claim 25, further comprising instructions that cause the processor to determine that the neighboring child block and the current child block are partitions of the parent block using a value for a split way element of the current child block, the value for the split way element representing a manner in which the parent block is split into the neighboring block and the child block.

28. The computer-readable storage medium of claim 25, wherein the instructions that cause the processor to construct the motion candidate list comprise instructions that cause the processor to avoid checking motion information of a left-neighboring block when a value of a split way element of the current child block indicates that the parent block is vertically split into two parts, a value of a block index indicates that the current child block is to the right of the neighboring child block, and when a bi-tree partition depth of the left-neighboring block is equal to a bi-tree partition depth of the current child block.

29. The computer-readable storage medium of claim 25, wherein the instructions that cause the processor to construct the motion candidate list comprise instructions that cause the processor to avoid checking motion information of an above-right neighboring block to the current child block when a value of a split way element of the current child block indicates that the parent block is horizontally split into two parts, a value of a block index indicates that the current child block is below the neighboring child block, and when a bi-tree partition depth of a left-neighboring block is equal to a bi-tree partition depth of the current child block.

30. A device for coding video data, the device comprising:
means for partitioning a parent block of video data into a neighboring child block and a current child block, wherein the neighboring child block and the current child block correspond to leaf nodes of a partition tree structure for the parent block;
means for constructing a motion candidate list for the current child block including a plurality of motion vector candidates such that the plurality of motion vector candidates omit data representative of a motion vector for the neighboring child block in response to partitioning the parent block into the neighboring child block and the current child block; and
means for coding motion information of the current child block using one of the plurality of motion vector candidates.
